(19) United States
(12) Patent Application Publication
(10) Pub. No.: US 2026/0319906 A1
(43) Pub. Date: Oct. 15, 2026

(54) Real-Time Scoring Mechanism for Monitoring Performance and Proactive Remediation

(71) Applicant: Zscaler, Inc., San Jose, CA (US)

(72) Inventors: Darshan Dhanaraj, Bangalore (IN); Ashok Kolachina, Milpitas, CA (US); Jay Makwana, Burnaby (CA); Satish Kalipatnapu, Alpharetta, GA (US); Prasannakumar Jobigenahally Malleshaiah, San Jose, CA (US); Karthik Gottiparthy, San Jose, CA (US); Francisco Javier Rodriguez Gonzalez, San Jose, CA (US); Vikas Srivastava, Columbus, OH (US); Barak Mendelevich, San Mateo, CA (US); Amitkumar Patel, Dublin, CA (US); Sreeni Tellakula, San Jose, CA (US); Tejas Budukh, Fremont, CA (US); Saroj Panigrahy, Fremont, CA (US)

(73) Assignee: Zscaler, Inc., San Jose, CA (US)

(21) Appl. No.: 19/225,309

(22) Filed: Jun. 2, 2025

(30) Foreign Application Priority Data
Apr. 9, 2025 (IN) 202541035465

(51) Int. Cl. G06F 11/34

(52) U.S. Cl. CPC G06F 11/3428

(57) ABSTRACT

Systems and methods for real-time scoring to monitor performance and provide proactive remediation via actionable insights which includes collecting one or more specific hardware and software performance metrics from one or more computing devices, assigning a weighted score to each performance metric, computing a composite score, and providing one or more actionable user recommendations.

### FIELD OF THE DISCLOSURE

The present disclosure generally relates to network and cloud security. More particularly, the present disclosure relates to systems and methods for real-time scoring, performance monitoring, and proactive remediation of end-user devices.

### BACKGROUND OF THE DISCLOSURE

IT administrators and desktop support engineers frequently encounter challenges in diagnosing device-related issues within complex IT environments that house a wide array of devices and configurations. From laptops, desktops, and mobile devices to peripherals and network-connected equipment, each component comes with unique specifications, operating systems, and potential compatibility issues. The vast diversity in hardware and software setups often results in highly variable performance and interaction issues, complicating the troubleshooting process. Engineers must be skilled in assessing and diagnosing issues across different device types, understanding nuances such as driver compatibility, network connectivity, and system updates, all while minimizing user downtime.

In addition, the complexity of these environments is exacerbated by increasing interconnectivity and the frequent use of virtual and cloud-based applications. As remote work becomes more common, desktop support engineers are often required to resolve issues in environments they cannot physically access, relying on remote diagnostic tools and user feedback, which can be limited in detail. The challenges of maintaining security protocols and ensuring seamless device communication further increase the difficulty of the role. Consequently, desktop support engineers must possess not only technical troubleshooting skills but also problem-solving agility and strong communication abilities to effectively manage the diverse and evolving demands of modern device support. Accordingly, there exists a need in the art for methods and systems for more effective monitoring and support that can provide an at-a-glance overview.

### BRIEF SUMMARY OF THE DISCLOSURE

The present disclosure relates to systems and methods for real-time scoring to monitor performance and provide proactive remediation via actionable insights. In various embodiments, the present disclosure includes a method having steps, a processing device configured to implement the steps, a cloud-based system configured to implement the steps, and as a non-transitory computer-readable medium storing instructions for programming one or more processors to execute the steps. The disclosure provides a system that generates real-time health scores for computing devices by collecting specific hardware and software performance metrics, weighting each metric based on its impact on device health, computing a composite score using a predefined algorithm, and providing actionable user recommendations. The system dynamically adjusts device health scores in real time by analyzing historical performance data to set thresholds and modifying metric weights based on recent performance trends.

Further, the system can compare in real-time device metrics against precomputed static thresholds derived from percentile analysis across multiple organizations, adjusting health scores to identify anomalies. The system can be a closed-loop learning system that automates detection of real-time device health degradation compared to industry standards by continuously evaluating system landscapes along multiple dimensions and different granularities to dynamically update thresholds.

In one aspect, disclosed is a method including the steps of collecting one or more specific hardware and software performance metrics from one or more computing devices, assigning a weighted score to each performance metric, computing a composite score using a predefined algorithm, and providing one or more actionable user recommendations.

In another aspect, disclosed is a method executable on a non-transitory computer-readable medium including the steps of collecting one or more specific hardware and software performance metrics from one or more computing devices, assigning a weighted score to each performance metric, computing a composite score using a predefined algorithm, and providing one or more actionable user recommendations.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a diagram illustrating an exemplary weighting scheme in accordance with one aspect of the present disclosure.

FIG. 6 is a diagram illustrating an exemplary dynamic threshold scheme in accordance with another aspect of the present disclosure.

FIG. 7 is a collections of graphs depicting various performance data results provided by exemplary aspects of the present disclosure.

FIG. 8 is a flow chart of an exemplary method for real-time scoring to monitor performance and provide proactive remediation via actionable insights for computing devices.

### DETAILED DESCRIPTION OF THE DISCLOSURE

Again, the present disclosure relates to systems and methods for real-time scoring which can be generally configured to monitor performance and can offer proactive solutions via, for example, actionable insights. Typical aspects can include a method including a processing device connected to a cloud-based system that can generate a health score for devices by gathering hardware and software performance metrics. The method can assign weights based on the significance of each metric. A recommendation can be made to a user based on the weighted results. The system can dynamically refine the health score in real time by analyzing historical performance data, establishing thresholds, and adjusting metric weights based on recent performance trends.

The system can assess device metrics against static thresholds derived from percentile analysis across various organizations. The system can modify the health score to detect anomalies. In some aspects, the method can include a closed-loop learning system configured to automatically identify device health and degradation by continuously evaluating the system landscape across multiple dimensions and granularities to update thresholds. The method can include steps to collect hardware and software performance metrics from computing devices, assign weighted scores, compute a composite score, and provide actionable user recommendations. Another aspect describes a method executable on a non-transitory computer-readable medium with similar steps for gathering performance metrics, weighting scores, calculating a composite score, and offering actionable recommendations

### § 1.0 CYBERSECURITY MONITORING AND PROTECTION EXAMPLES

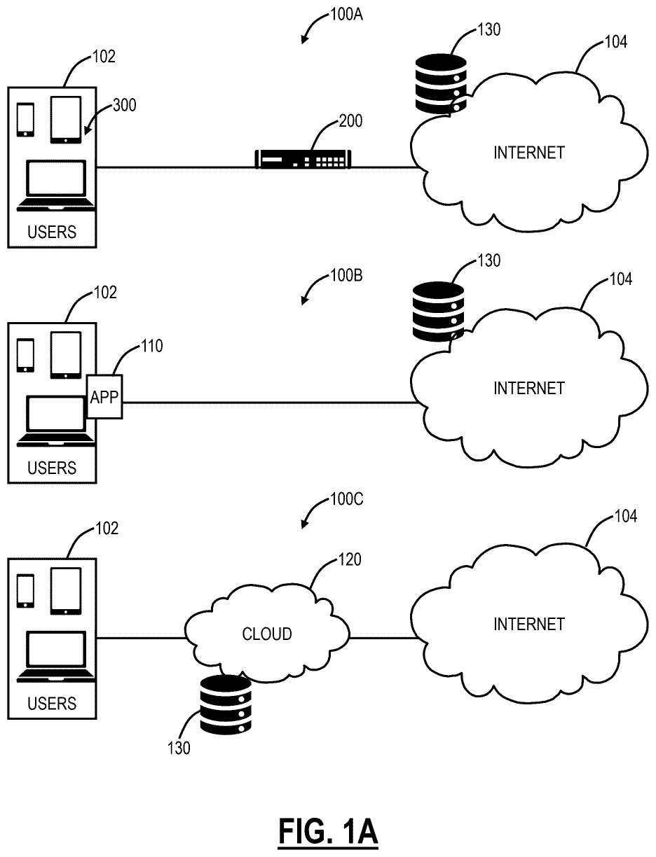

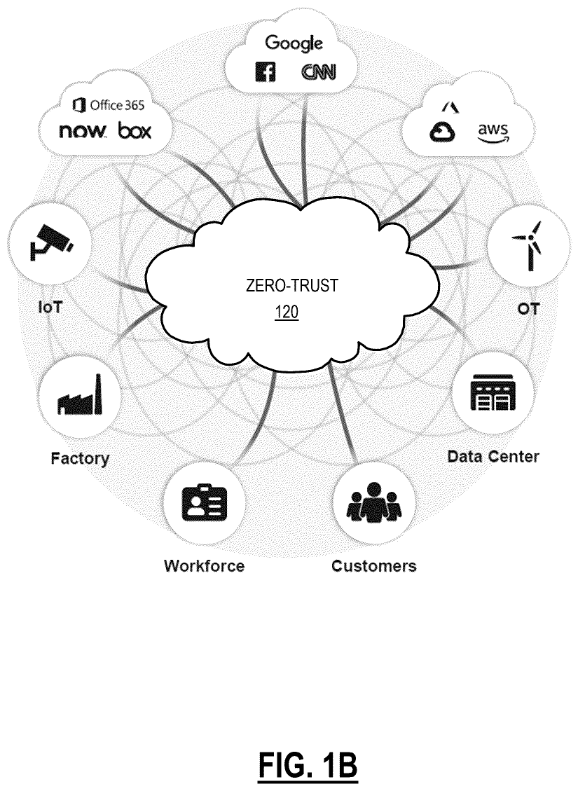

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

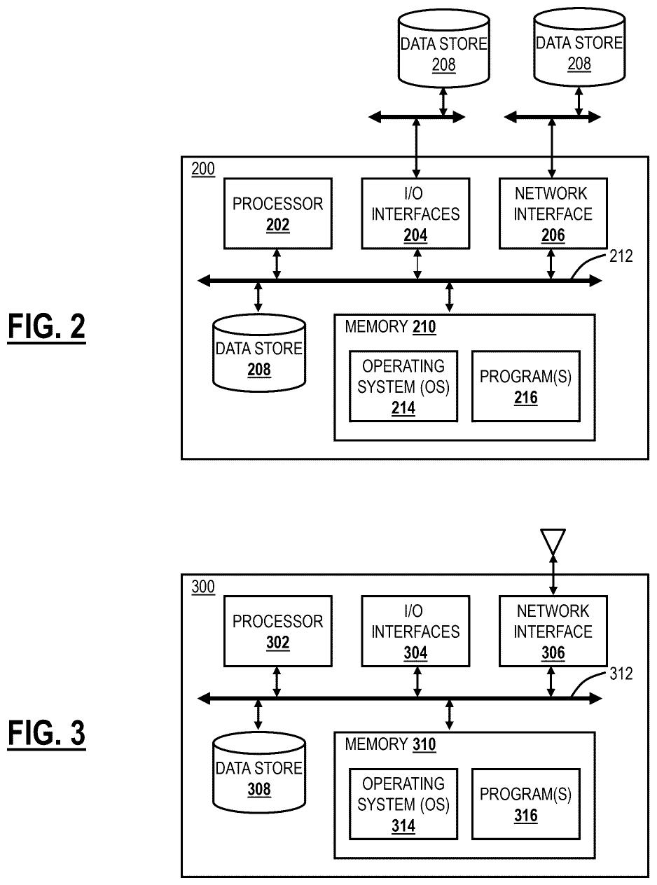

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, loT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 EXAMPLE SERVER ARCHITECTURE

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 EXAMPLE COMPUTING DEVICE ARCHITECTURE

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 APPLICATION FOR TRAFFIC FORWARDING AND MONITORING

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

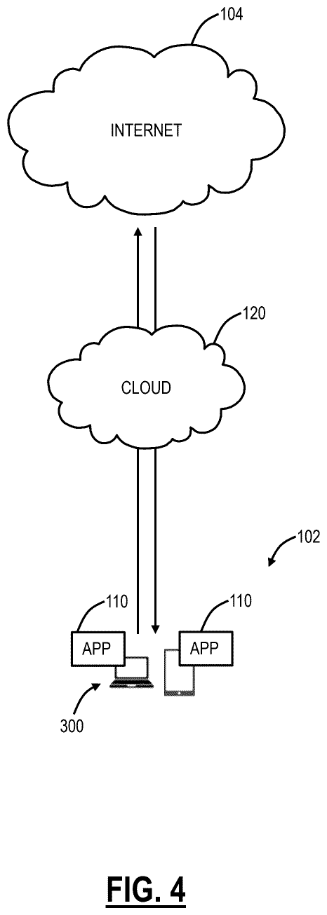

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Real-Time Health Scores

The present disclosure relates to a system which generates real-time health scores. As used herein, the terms “the system” and “the method” generally refer to the object of this disclosure and are to be used interchangeably. The health scores can pertain to computing devices, such as and without limitation, laptops and desktops, smartphones and tablets, servers, networking equipment (e.g., routers and switches), IoT devices (e.g., smart thermostats, security cameras, etc.), industrial equipment (e.g., robotic arms, sensors), gaming consoles, or the like. The method can be used for devices that are essential for work or personal use, or devices which would be negatively affected by unexpected breakdowns. The method can be used for communication devices and enterprise devices to ensure smooth business operations. Further, as more devices connect to the internet, it becomes increasingly important to monitor their health to prevent costly production downtimes, breaks in communication, and inefficiencies.

The system can monitor devices for preventative maintenance, for example by providing regular monitoring which can detect issues early allowing for proactive repairs or adjustments before the failure occurs. The system can improve device performance via the device health score. The device health score can help optimize device performance by identifying specific areas that need updates, cleaning, or settings adjustments. The method can encourage cost saving by, for example, preventing major failures through health score monitoring and can avoid repair or replacement costs. This is critical for devices like servers and industrial equipment where replacement is costly and time consuming. The method can extend the device lifespan by addressing health issues early, thus allowing devices to last longer and reduces the need for frequent replacements.

The system, contemplated as being a part of the cloud 120, can collect hardware and/or software performances metrics related to a device. The system can use one or more monitoring tools and one or more software agents which can track performance indicators. Further, the system can perform such monitoring in real time. The system can monitor hardware performance such as CPU usage and temperature by monitoring, for example, usage percentage, the number of active threads, and CPU temperature. The system can collect metrics via built-in system utilities. For example, the system can use task manager, activity monitor, or “top” or a specialized monitoring software (e.g., Monitor, Open Hardware Monitor, or the like) to track CPU activity and temperature. The system can monitor hardware metrics associated with memory or RAM. The system can monitor total memory usage, available memory, page file/swap usage, or the like. The system can perform memory monitoring with OS utilities or applications like Windows Performance Monitor free command line tools like “free” to see and/or record real time memory consumption.

The system can monitor disk health and usage. The system can monitor read/write speed, disk space usage, temperature, self-monitoring, analysis, and reporting technology (SMART) status, or the like. The system can collect disk health by using utilities like CrystalDiskInfo or “smartctl” to pull SMART data which can highlight potential failures or deterioration. The system can monitor battery capacity, charging cycles, battery temperature, and battery discharge rate. More generally, the system can monitor battery health and status. The battery can be monitored via BatteryInfoView, coconutBattery, or the like and can provide insights into battery wear level and performance. The method can monitor throughput and latency such as upload/download speed, latency, and packet loss. The system can collect network and latency data via monitoring tools such as Wireshark or SolarWinds or via basic commands like “ping” and “traceroute.”

The system can monitor and collect data based on software performance. The system can measure application response time or the time taken for an application to load or respond to commands. Such data can be collected via profiling tools like AppDynamics or New Relic which can measure response times for various processes and applications. The system can measure error rates and logs, such as the frequency and type of errors (e.g., application crashes and system errors). The system can collect error metrics by log aggregation tools (e.g., Splink, ELK stack) and can centralize and analyze logs, and can use application performance management (APM) tools to provide insights into error trends. The system can monitor service availability and uptime, and more particularly uptime percentage, downtime duration, mean time to repair (MTTR). The system can use monitoring software such as Pingdom or Nagios to track uptime and service availability. Alerts can be provided to indicate downtime.

The system can monitor file system utilization, such as file access times, file size, number of files, or fragmentation. The file system utilization can be monitor via disk monitoring utilities, (e.g., Defraggler) or command-line utilities to analyze file system health and fragmentation levels. The system can monitor software-level network connection metrics, such as the number of open connections, connection failure rates, retransmission rates, or the like. The system can collect software-level network connection metrics via firewall or network analysts tools (e.g., Sysmon, “netstat”, etc.) and can provide insights into open connections and the rate of connection failures. The system can monitor security and vulnerabilities for example by examining known vulnerability, antivirus scans, or firewall states by collecting security software logs, antivirus data, endpoint protection platform (e.g., Norton, CrowdStrike) data, and can report system vulnerabilities.

More generally, the system can collect any software and/or hardware data pertaining to one or more devices. The data can be included in a health score. Generally, the system can weight the one or more metrics, compute a composite score, and can optionally provide actionable recommendations. More generally, the method can involve one or more steps to evaluate and respond to the device's performance data. Again, the system can weight each metric based on the impact on device health. As defined herein, device health generally refers to a measure of the overall operational status and performance of a computing device. Moreover, device health can reflect how well the device is functioning in terms of hardware, software, and system processing. A high level of device health can indicate that the device is operating optimally, while a lower level can suggest potential performance issues or risks of failure that may need attention. Some aspects of device health can include hardware condition, or the condition of physical components such as the CPU, memory, hard drive, battery, and sensors. Key indicators of hardware health condition can include, but are not limited to CPU temperature, battery health, and disk health. Other aspects of device health can involve software health, such as operating system, application, and driver health. Key indicators of software health condition can include, but are not limited to application performance, error logs, and update status. More generally, device health can represent system stability and reliability such as how well the device maintains stability over time.

Different metrics can have varying levels of importance for determining the device health. For example, some metrics might have a more immediate or severe effect on performance and/or reliability and will receive a higher weight. In example only, CPU temperature might be heavily weighted because overheating can quickly cause permanent damage. Memory usage may have average or moderate weight, as high memory usage can affect performance but is typically less critical than overheating. Further, battery health might receive a lower weight on desktops, but a high weight on mobile devices since battery failure has more significant impact on portable devices. In some aspects the weights could be defined based on factors such as the risk of failure associated with the metric (e.g., overheating is a high risk factor), user experience impact (e.g., slow application response time affects usability), and industry standards for device performance.

After weighting each metric, the system can use an algorithm to combine the weighted values into a single comprehensive health score. This score can simplify the overall health status of the device into a single interpretable number or percentage. In example only, a weighted average formula can be used, where each metric is multiplied by its assigned weight, and the sum of these values can be normalized within a scoring range (e.g., 0 to 100). The following is an example only of a weighted average.

$$Composite Health Score = \frac{\sum ( Metric Value * weight )}{\sum weights} * 100$$

In some aspects, thresholds can be established within the algorithm to interpret the score (e.g., a score above 85 is “Good,” 60-85 is “Moderate,” below 60 is “Poor”). Some algorithms adjust the weights dynamically based on trends, such as increasing the weight of a metric that consistently shows negative trends over time. Algorithms can continuously adjust thresholds by analyzing historical data. For example, if CPU temperatures have been gradually increasing, the score might reflect this trend by lowering thresholds to mark “Good” health. Based on the composite score, the system can provide tailored recommendations to address any detected issues, helping users improve device health. Actionable insights can range from basic maintenance suggestions to specific software or hardware adjustments. For example, if CPU usage is high, the system might recommend closing certain background applications or running a virus scan if a process seems suspiciously resource-intensive. For disk health issues, it could suggest backing up files, running disk cleanup, or replacing the drive if indicators suggest an impending failure. If network latency is high, the system might recommend checking Wi-Fi settings, resetting the router, or switching to a less congested network channel. If battery health is declining, it could suggest adjusting power settings, avoiding full discharges, or replacing the battery.

In various embodiments, the recommendations can be provided to a user of the computing device 300 via the application 110 operating on the computing device 300. This can be via a Graphical User Interface (GUI) of the application 110, via notifications sent to and displayed on the computing device 300, and the like.

The system can dynamically adjusts device health scores in real time by analyzing historical performance data to set thresholds and modifying metric weights based on recent performance trends. The process can include continuously monitoring performance data, comparing it with historical trends, and using the information to fine-tune the thresholds and weights assigned to specific metrics. As such, the system can reflect the true state of the device's health more accurately, especially as performance characteristics evolve. The following is an example of dynamic adjustments in accordance with the present disclose and without limitation.

### CPU Dynamic Adjustment

A device's CPU typically runs at 50-60° C. under normal load but recently has been consistently reaching 70° C., even though the same applications are being used. The system, recognizing this new trend, adjusts its health score algorithm to assign more weight to the CPU temperature metric. It might also lower the “healthy” temperature threshold from 75° C. to 70° C., marking anything above this as potentially problematic. The device health score decreases slightly to prompt the user to check for dust buildup, improve ventilation, or limit intensive applications.

### Battery Health Tracking

A laptop's battery initially had a high capacity but has started to degrade over time, with its charge capacity dropping to 80% of its original level within six months. By comparing current battery capacity against historical data (showing steady decline), the system increases the weight on battery health in the composite score. The “good health” threshold may also be lowered to reflect the new reality of battery wear, adjusting the score as degradation accelerates. The health score reduces slightly, alerting the user to the battery's declining state, recommending power management settings, and notifying them that a replacement might soon be necessary.

### Network Latency and Stability

A remote worker's network usually experiences latency between 20-50 ms. However, recently, the latency has consistently spiked to 100 ms or higher due to increased network traffic. The system detects this trend and adjusts the weight on the network latency metric in the composite health score, lowering the acceptable latency threshold and giving it a higher weight to reflect its impact on work performance. The system notifies the user that their network health is declining, suggesting they check for issues with their ISP, optimize network settings, or reduce background network usage.

### Disk Health and Space Usage

A device's disk health has historically shown low error rates and ample free space. Recently, however, disk space has been filling up quickly, and error rates are increasing due to repeated intensive operations. The system notices this pattern, increasing the weight of disk usage in the score calculation and lowering the free space threshold to highlight that the device is near capacity. Additionally, the score is adjusted downward to indicate potential health risks if the drive reaches full capacity. The system alerts the user to delete unused files, optimize storage, or consider a drive upgrade before performance is further impacted.

### Memory Usage

A computer usually uses 40-50% of its available memory for normal applications, but it has recently started using 70-80%, causing noticeable slowdowns. By analyzing historical data, the system recognizes that this is an abnormal increase and places more weight on memory usage. It also adjusts the acceptable range, lowering the threshold to indicate that 80% usage may now signify poor health rather than moderate health. This adjustment prompts the system to provide actionable recommendations, such as upgrading memory, closing unnecessary applications, or identifying resource-hungry programs.

The system can perform an initial setup. The initial setup can include assigning equal weights to hardware, usage, and software scores. The following illustrates an example of initial setup weights:

$${w}_{1} = {w}_{2} = {w}_{3} = 1 / 3$$

The system can capture user feedback. More specifically, the system can collect feedback from users about their experience. In the initial setup, the system might assign equal importance to hardware, usage, and software metrics, each contributing equally to the overall device health score. For example, hardware stability, app performance, and usage patterns each receive 33% weight, a 10% drop in any one area (like hardware) will reduce the overall score by 3.3%, keeping the assessment balanced across all aspects This feedback can be a numerical rating (e.g., 1 to 5 stars) or textual feedback (e.g., sharing thoughts or in written form). Moreover, users can provide feedback by submitting the numerical rating or textual feedback to assist in identifying areas for improvement.

The system can include a sentiment analysis. The sentiment analysis can be a tool or algorithm to convert textual feedback into a sentiment score. In example, for simplicity, assume the sentiment score is normalized between 0 (very bad) and 1 (very good). For instance, if the system calculates an average score of 0.8 for hardware, usage, and software performance but receives a sentiment score of 0.4 from a user, the system recognizes a significant deviation of 0.4, indicating that users are experiencing problems despite the high performance metrics.

From there, the system can calculate the deviation. More generally, the system can calculate the difference between the system's score (e.g., average of hardware, usage, and software scores) and the user's sentiment score. In some aspects, the deviation is the difference between the overall performance score, which includes averages from metric from hardware usage and software and the sentiment score provided by the user. The system can adjust the weights based on the deviation. For example, if the user's sentiment is lower than the system's score, the system can decrease the weights of one or more factors contributing to the high score and can increase the weights of the factors contributing less to the score.

In other aspects, the system can perform a normalization. Normalization can be a process that ensures the adjusted weights of various performance metrics add up to one, maintaining a consistent scoring system. For instance, if after adjusting the weights, hardware is assigned a weight of 0.5, software a weight of 0.3, and usage a weight of 0.2, normalization confirms that these values total 1.0, allowing the system to accurately reflect the relative importance of each factor in the overall health score. The normalization can ensure that the weights sum up to one after adjustment. The following is an illustrative example of a code scheme embodying an aspect of the system of the instant disclosure.

Initially, the weights for hardware, usage, and software are each set to one-third, indicating that all three components are equally important. The process begins by defining a function, which takes in four scores along with the current weights. Within the function, the first step is to calculate the system's overall score by computing a weighted sum of the hardware, usage, and software scores using the current weights. Next, the function determines the deviation by subtracting the system score from the user-provided sentiment score. This deviation indicates how much the system's assessment differs from the user's sentiment. To adjust the weights based on this deviation, an adjustment factor (α). This factor controls the sensitivity of the weight adjustments. Each weight is then updated by adding the product of α, the deviation, and the difference between the respective score and the system score. After adjusting the weights, they can be normalized so that their total sums up to one. This can ensure that the weights remain proportional and meaningful. The normalization is achieved by dividing each weight by the total sum of all three weights. To demonstrate how this function works, consider an example where the hardware score is 80, the usage score is 70, the software score is 75, and the user sentiment score is 0.6 (which could represent a 3 out of 5-star rating). By calling the adjust_weights function with these values and the initial weights, the function computes the adjusted weights based on the user's feedback. Finally, the new weights are printed with four decimal places of precision, providing a refined weighting that better aligns with the user's sentiment.

As such, the approach of the instant application can be adapted to an organizational level by averaging the sentiments of all users and then applying the same logic above. In typical aspects, the above is applied at the organizational level instead of the user level. As a result, the system can more effectively normalize the overall sentiment rating and can facilitate more accurate weight updates.

The system can compare real-time device metrics against precomputed static thresholds derived from percentile analysis across multiple organizations, adjusting health scores to identify anomalies. In this approach, the system can continuously compare real-time device metrics (such as CPU usage, memory usage, or battery health) against precomputed static thresholds, which can be established by analyzing performance data from a wide range of devices across different organizations. These thresholds are usually set at certain percentiles (e.g., the 90th or 95th percentile), representing performance standards that most devices fall within; if a device's metrics exceed these limits, it could indicate a potential issue or anomaly. In example only, Suppose the system sets a CPU temperature threshold at the 90th percentile based on an analysis of many devices' typical operating temperatures across several companies. This threshold might be set at 80° C., meaning that 90% of devices typically operate below this temperature under similar conditions. If a device suddenly starts operating at 85° C., the system identifies this as an anomaly, lowering the health score and notifying the user. The alert might include recommendations for addressing the issue, such as cleaning the device's fans or limiting intensive processes to prevent overheating, as the high temperature is uncommon and could impact device health. This method can ensure device health scores reflect not just individual performance but also how the device compares to industry norms, flagging potential issues before they escalate.

The system can include a closed-loop learning system that automates detection of real-time device health degradation compared to industry standards by continuously evaluating system landscape along multiple dimensions and different granularities to dynamically update thresholds. The closed-loop learning system can continually monitor the device's health across multiple dimensions, such as CPU usage, battery capacity, and network stability, comparing these metrics to industry standards. As described herein, multiple dimensions can refer to various aspects or categories of performance metrics that can be monitored to assess the overall status of a device. Each dimension provides insights into different elements of device functionality and health. Here are some key dimensions commonly considered. This system automatically detects and learns from trends over time, adjusting thresholds dynamically based on real-time and historical data to better detect early signs of performance degradation. In example only, pertaining to a closed-loop system monitoring a fleet of devices, each with various performance dimensions like memory utilization, disk health, and software stability. Initially, the system sets thresholds based on industry averages, but over time, it observes that devices in certain environments (e.g., high-use settings) experience higher memory usage. The system “learns” this trend and updates the memory threshold specifically for those devices, flagging degradation only when memory usage exceeds the adjusted limit. This helps identify issues like memory leaks or insufficient RAM in real time, prompting recommendations such as software updates or memory upgrades to prevent further decline. By adjusting in response to observed conditions, the system becomes more accurate in detecting and addressing device health issues relevant to specific use cases.

### § 5.1 Process

The instant application discloses a real-time scoring mechanism which can facilitate performance monitoring and proactive remediation of end-user devices by providing actionable insights. Some aspects of the present disclosure involve assigning a device health score. The device health score can offer a centralized perspective, summarizing the performance of individual devices and the entire organization into a concise score. This score can enable users to quickly pinpoint factors affecting device health without sifting through numerous data streams to identify root causes. It can assist in detecting significant issues impacting the organization or individual users and helps identify devices due for hardware refresh-a common organizational process.

Moreover, support staff, such as desktop support engineers often struggle with diagnosing device-related issues in complex environments with diverse devices and configurations. The device health score can provide an at-a-glance overview of the device health. The system can incorporate additional metrics for devices, such as a separate score for device-specific issues as they become necessary. This can simplify monitoring for desktop support engineers, leading to faster issue resolution. By exposing the device-specific health score, desktop support can monitor and address issues independently, without relying on other teams (such as the Network team), thereby reducing MTTR.

The device score measurement of the present disclosure for a given user/organization can involve gathering data of two main components of the device, namely the hardware and software. As such, there are at least two possible approaches to calculating the device score. In example, the first approach is to group devices based on their type (Mac, PC), operating system, RAM size, CPU cores, etc. Then, the score for each group can be derived by considering the usage and other factors. In an alternative example, a derived value can be created based on the hardware details and/or hardware utilization to obtain a single value which represents the device score.

The system can assign weights to different features and can be combined to form a single value which can represent the state of the device. This can provide the user with some flexibility to assign custom weights which can help them prioritize one component vs. another component. Provided below is a non exhaustive list of some of the device metrics which can be consumed.

### Static

a. CPU->No. of Cores, logical processors, max speed ghz, pct kernel, pct total, pct user
b. Physical disk
c. Ram size

### Dynamic

d. Memory->total memory, used, free, pct used, swap used,
e. Disk->Total disk space, pct used, rd bps, wt bps
f. Battery
g. OS->Name, version
h. Uptime
i. Wifi->Signal Strength, SNR (Signal to noise ratio)
j. Device Events->high swap, application crash, unexpected shutdowns, system crash etc
k. Process->Number of processes, Individual process name and its cpu/mem/disk usage

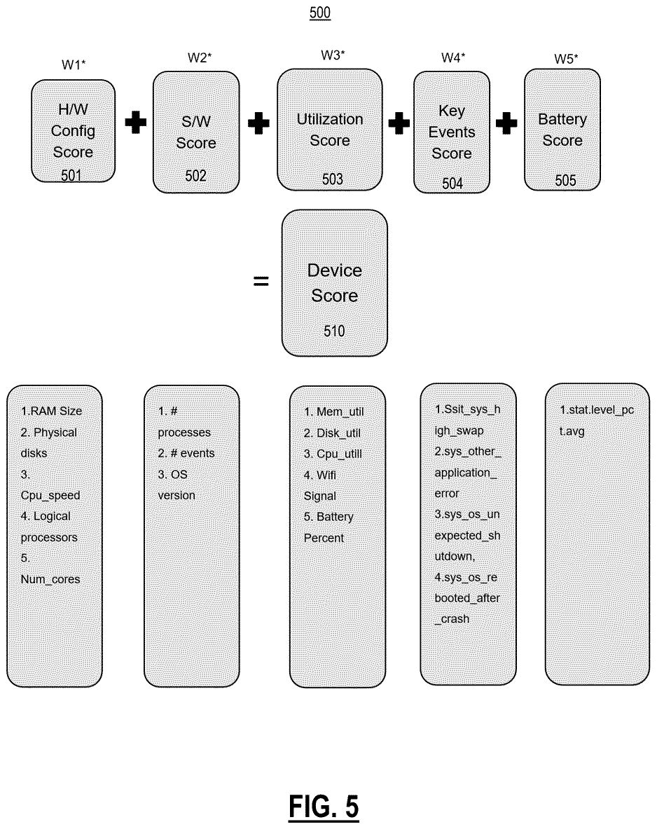

Turning now to FIG. 5, a classification diagram 500 of the foregoing categories is shown and described. The system can include a ranking and weighted average to determine a value which can indicate the performance of the device. The system of the classification diagram 500 can consider a configuration score 501, a software score 502, a utilization score 503, a key event score 504, and a battery score 505. The system of the classification diagram 500 can perform a summation or any operation to determine a device score 510. The device score 510 can represent one or more constituents of the system of the classification diagram 500. Notably, the system of the classification diagram 500 can consider any parameter disclosed above or present in the disclosure.

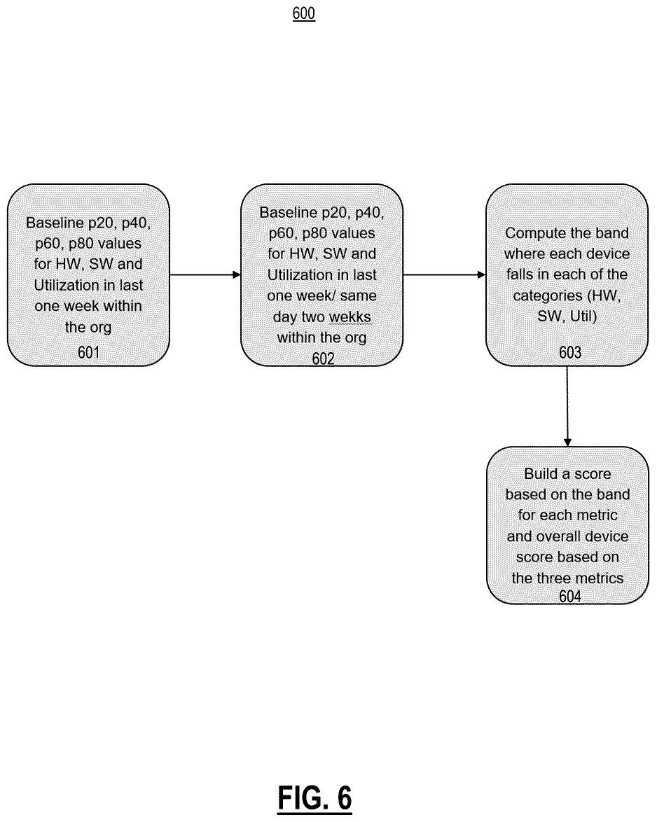

Turning now to FIG. 6, a flowchart describing a dynamic thresholding 600 scheme is shown and described. The dynamic thresholding 600 can include a first baseline 601, a second baseline 602, a band compute 603, and a score build 604 step. The first baseline 601 can be baseline p20, p40, p60, p80 values for hardware and software Utilization in last one week within the organization. The second baseline 602 can be baseline p20, p40, p60, p80 values for HW, SW and Utilization in last one week within two weeks within the organization. The band compute 603 can be compute the band where each device falls in each of the categories. The score build 604 can be building a score based on the band for each metric and overall device score based on one or more metrics.

The dynamic thresholding can include everyday benchmarks which can be calculated for each organization by examining the measurement of the metric for a period of time. For example, the measurements for the last 7 days can be examined. In other examples by calculating the benchmark by incorporating data from two days (e.g., one from the same day in the previous week and the other from the same day two weeks earlier. The device performance for a given user can be compared against the baseline to get an associated score. The overall score for that organization can be based on the median value of all the users. More generally, the dynamic threshold can be a method of establishing performance benchmarks for device metrics that adjust over time based on historical data. This allows organizations to maintain relevant performance standards reflective of their specific usage patterns. Here are definitions and examples for key terms mentioned in the material.

The system can incorporate custom thresholding. The custom thresholding can include determining static thresholds for individual components such as RAM size, CPU seed, cores, and CPU/memory/disk/battery/Wi-Fi utilization by computing percentiles across all organizations. As such, the custom thresholding can establish optimal values that better indicate device performance. Unlike a baseline approach which calculates thresholds for a specific organization, the system can use a precomputed value to compare real-time device metrics and generate a device score. As such, the custom threshold can aid in scalability by eliminating the need for benchmark computations. The following is a non-exhaustive list of potential advantages and examples of the system of the present disclosure:

Centralized View: Provides a unified and concise score summarizing the performance of individual devices and the entire organization. This centralized perspective helps in efficiently managing device health.

Quick Issue Identification: Enables customers to swiftly identify factors affecting device health without the need to sift through multiple data streams. This accelerates the process of pinpointing root causes and addressing them promptly.

Proactive Remediation: Facilitates early detection and resolution of significant issues impacting the organization or individual users. This proactive approach minimizes downtime and ensures smoother operations.

Hardware Refresh Insights: Assists in identifying devices that are due for hardware refresh, a common process in organizations. This helps maintain optimal device performance and prevents potential issues related to outdated hardware.

Simplified Monitoring: Offers desktop support engineers an at-a-glance overview of device health. This simplification allows for easier monitoring and management of device-specific issues, leading to more efficient support operations.

Faster Issue Resolution: With additional metrics incorporated for devices, a separate score for device-specific issues is provided. This targeted approach allows desktop support engineers to quickly address and resolve issues, enhancing overall support efficiency.

Independent Issue Management: By exposing device-specific health scores, desktop support teams can monitor and address issues independently, without relying on other teams (such as the Network team). This independence streamlines the troubleshooting process and reduces bottlenecks.

Reduced MTTR: The solution significantly reduces the Mean Time To Resolution by enabling faster identification and remediation of issues. This leads to improved device performance and user satisfaction.

Enhanced Decision Making: Provides actionable insights that inform better decision-making regarding device management and maintenance. This data-driven approach ensures informed and effective strategies for maintaining device health.

Scalability: The use of precomputed values for static thresholds eliminates the need for dynamic benchmark computations, enhancing the scalability of the solution across large organizations.

### § 5.2 Example Use Cases

The following discussion is an example use case of the system disclosed herein, the spirit of which is non-limiting and in example only. Consider a laptop device. Laptop allocation can be optimized by tailoring it to the specific needs of each department. This ensures that users receive laptops with the right specifications, preventing both overloading and underutilization of resources. The benefits of department-specific laptop allocation are as follows: First, it ensures that each department receives laptops tailored to their unique requirements; for example, high-performance laptops for development teams and lightweight models for sales teams. This tailored approach prevents overloading systems by providing adequate specifications that can handle the workload, thereby avoiding performance bottlenecks and potential system failures. Moreover, it promotes cost efficiency by preventing overspending; high-end laptops are allocated only where necessary, which reduces unnecessary expenditure on expensive hardware for roles that don't require it. This strategic allocation can lead to long-term savings, as properly matched laptops typically have longer lifespans and incur lower maintenance costs. Enhanced productivity is another significant advantage. Users with appropriately specified laptops can work more efficiently and with fewer disruptions, resulting in higher satisfaction and output. The right tools enable them to complete tasks more effectively and quickly. Finally, this approach fosters balanced resource utilization, preventing scenarios where powerful laptops are underused or basic models are overburdened, ensuring that all resources are utilized effectively.

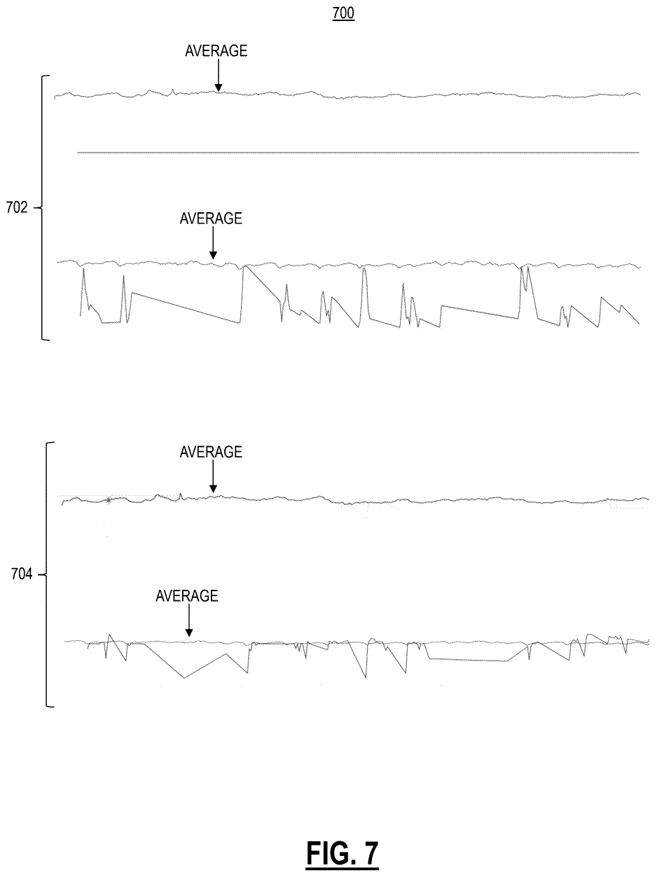

Turning now to FIG. 7, a pair of data graphs 700 depicting experimental results of the deployment of a system disclosed herein is shown and described. The first data graph 702 depicts a hardware refresh case, wherein the superjacent graph is a hardware score, and the subjacent graph is a usage score. In this example, the hardware components are outdated and are being used to their maximum capacity, indicating a clear need for a hardware refresh. As shown in the image below, the hardware score and the usage score are significantly lower than the organizational average. The second data graph 704 depict a 4 year old device. As shown, the user has been using the laptop for over 4 years and reports no issues with the system, which is reflected in both the hardware score and the usage score. Regardless, the system can identify recent software updates or upgrades that might be too resource-intensive for the current hardware, causing a performance drop.

The device health monitoring system can provide valuable remediation strategies across various scenarios to enhance performance and longevity. For instance, in the case of hardware upgrade recommendations, devices with low hardware scores due to outdated components, such as insufficient RAM or old CPU models, can be identified. The system might suggest upgrading RAM or replacing old HDDs with SSDs to improve performance. If the device is beyond economical repair or upgrade, it may recommend a complete replacement. Additionally, it can schedule hardware refresh cycles for devices approaching their end-of-life.

In another example, software optimization can address devices exhibiting high CPU or memory usage due to inefficiencies. The system could prompt users to update outdated applications that may include performance patches or identify and uninstall bloatware and rarely used applications consuming resources. It can also optimize startup programs by disabling unnecessary ones to enhance boot times and overall performance. For devices showing declining battery health scores, indicating poor battery performance or potential failure, the system can facilitate battery life improvement. It may recommend adjusting power settings for better efficiency, advise replacing critically low batteries, or provide user education on battery maintenance practices, such as avoiding overcharging.

In terms of disk space management, if devices have low disk space that impacts performance and prevents software updates, the system could suggest a disk cleanup to delete temporary files, duplicates, or large unused files. It may also recommend upgrading to larger HDDs or SSDs and encourage users to move files to cloud storage to free up local disk space. Network connectivity issues can also be addressed; for devices experiencing poor Wi-Fi signal strength or high latency, the system might advise relocating the device closer to the Wi-Fi access point, updating or reinstalling network drivers, or inspecting network hardware such as routers or access points for issue.

To tackle application crash analysis, the system can identify frequent application crashes that lower the software score, indicating instability. It may encourage users to update applications to their latest versions, suggest reinstalling problematic software to fix potential corruption, and verify application compatibility with the operating system. Lastly, for overheating devices, which report high temperature readings that can damage hardware and reduce lifespan, the system might advise cleaning dust from vents and fans to improve airflow, suggest inspecting and repairing cooling components like heat sinks, or recommend using devices in cooler environments or investing in cooling pads. By implementing these strategies, a device health monitoring system can effectively enhance performance and extend the lifespan of computing devices.

### § 5.3 Method for Real-Time Scoring

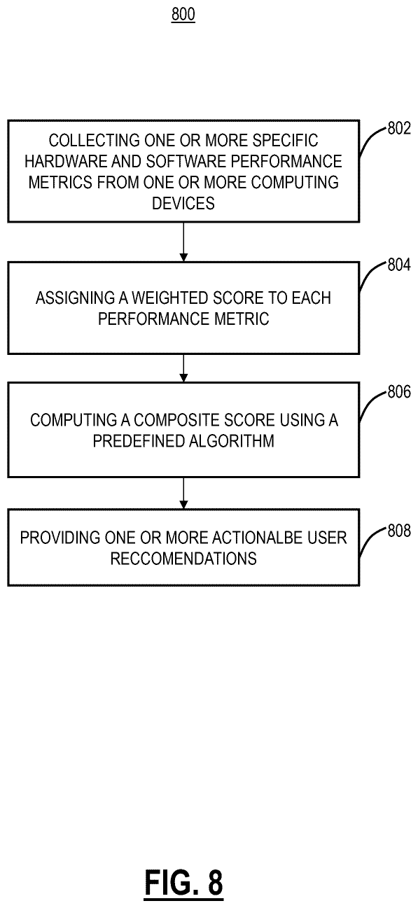

Turning now to FIG. 8, a method 800 for real-time scoring to monitor performance and provide proactive remediation via actionable insights. The method 800 can include collecting 802 one or more specific hardware and software performance metrics from one or more computing devices. The method 800 can include assigning 804 a weighted score to each performance metric. The method 800 can include computing 806 a composite score using a predefined algorithm. The method 800 can include providing 808 one or more actionable user recommendations.

The method 800 can include wherein the weighted score is based on an impact on the computing device from the metric. The method 800 can include wherein the composite score is a health score that is dynamically adjusted in real time. The method 800 can include wherein the health score is compared against a precomputed static threshold defined from a percentile analysis across one or more organizations. The method 800 can include further including analyzing a historical performance data to define one or more thresholds. The method 800 can include further including modifying the weighted score based on a recent performance trend.

The method 800 can include further including adjusting the composite score to identify an anomaly. The method 800 can include wherein the method is executed in a closed loop learning system. The method 800 can include further including comparing the composite score to an industry standard. The method 800 can include wherein the composite score is continuously evaluated along multiple dimension and different granularities.

### § 6.0 CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
collecting one or more specific hardware and software performance metrics from one or more computing devices;
assigning a weighted score to each of the hardware and software performance metrics;
generating, for a computing device of the one or more computing devices, a composite score; and
providing one or more actionable user recommendations based on the composite score of the computing device.

2. The method of claim 1, wherein the weighted score is based on an impact on the computing device from the metric.

3. The method of claim 1, wherein the composite score is a health score that is dynamically adjusted in real time.

4. The method of claim 3, wherein the health score is compared against a precomputed static threshold defined from a percentile analysis across one or more organizations.

5. The method of claim 1, further including analyzing a historical performance data to define one or more thresholds.

6. The method of claim 1, further including modifying the weighted score based on a recent performance trend.

7. The method of claim 1, further including adjusting the composite score to identify one or more anomalies.

8. The method of claim 1, wherein the method is executed in a closed-loop learning system.

9. The method of claim 1, further including comparing the composite score to an industry standard.

10. The method of claim 1, wherein the composite score is continuously evaluated along multiple dimensions and different granularities.

11. A non-transitory computer-readable medium comprising instructions that, when executed, cause one or more processors to perform steps of:
collecting one or more specific hardware and software performance metrics from one or more computing devices;
assigning a weighted score to each of the hardware and software performance metrics;
generating, for a computing device of the one or more computing devices, a composite score; and
providing one or more actionable user recommendations based on the composite score of the computing device.

12. The non-transitory computer-readable medium of claim 11, wherein the weighted score is based on an impact on the computing device from the metric.

13. The non-transitory computer-readable medium of claim 11, wherein the composite score is a health score that is dynamically adjusted in real time.

14. The non-transitory computer-readable medium of claim 13, wherein the health score is compared against a precomputed static threshold defined from a percentile analysis across one or more organizations.

15. The non-transitory computer-readable medium of claim 11, further including analyzing a historical performance data to define one or more thresholds.

16. The non-transitory computer-readable medium of claim 11, further including modifying the weighted score based on a recent performance trend.

17. The non-transitory computer-readable medium of claim 11, further including adjusting the composite score to identify an anomaly.

18. The non-transitory computer-readable medium of claim 11, wherein the steps are executed in a closed loop learning system.

19. The non-transitory computer-readable medium of claim 11, further including comparing the composite score to an industry standard.

20. The non-transitory computer-readable medium of claim 11, wherein the composite score is continuously evaluated along multiple dimension and different granularities.
